(19) United States
(12) Patent Application Publication
(10) Pub. No.: US 2026/0042683 A1
(43) Pub. Date: Feb. 12, 2026

(54) WATER PURIFIER

(71) Applicant: Qingdao Ecopure Filter Co., Ltd., Qingdao (CN)

(72) Inventor: Zhibin ZOU, Qingdao (CN)

(21) Appl. No.: 19/225,282

(22) Filed: Jun. 2, 2025

(30) Foreign Application Priority Data
Jun. 3, 2024 (CN) CN202421251069.7

(51) Int. Cl. C02F 1/00

(52) U.S. Cl. CPC C02F 1/003; C02F 2201/004; C02F 2201/005; C02F 2201/009; C02F 2209/10; C02F 2307/04

(57) ABSTRACT

The present application provides a water purifier comprising a water tank and a cover assembly. The cover assembly comprises a cover assembly shell defining a receiving chamber, a water suction and filtration module, and a water outlet. The water suction and filtration module comprises a water pump, a filtration unit, and a connecting unit fluidly connecting the water pump and the filtration unit. The receiving chamber is isolated from the water chamber. The water pump and the connecting unit are disposed in the receiving chamber in a substantially horizontal arrangement. The water outlet protrudes from the water tank and the purified water flows downward from the water outlet.

### CROSS-REFERENCE TO RELATED APPLICATIONS

This application claims the benefit of and priority to CN Application No. 202421251069.7, filed on Jun. 3, 2024, which is hereby incorporated by reference in its entirety.

### FIELD

The invention relates to the technical field of water purification device, in particular to a water purifier having a compact cover assembly.

### BACKGROUND

A water purification device, also commonly known as a water purifier, is a water treatment device specifically used to improve water quality. It removes impurities, heavy metals, bacteria, viruses and other harmful substances in water through various filtering and purification technologies, thereby providing safe and healthy drinking water and ensuring people's health and quality of life. The key components of a water purifier include filtration unit and water pump. The filtration unit can usually include various filtration materials, such as activated carbon, ultrafiltration membrane, reverse osmosis membrane, etc., to achieve different water treatments. The water pump can drive the water to flow in the water purifier.

In family life, people usually use a small desktop water purifier, which includes a water tank for storing raw water and a filtration unit and a water pump disposed inside the water tank. Usually, the filtration unit and the water pump are independently installed inside the water tank. The filtration unit and the water pump disposed in this way, on the one hand, make the arrangement of the water channels connecting these structures complicated, and on the other hand, make the overall structure inside the water tank not compact enough, which has the disadvantage of low integration.

### SUMMARY

This summary is meant to provide various examples of the aspects disclosed herein and is not intended to be limiting the scope of the disclosure in any way. For example, any feature included in an example of this summary is not required by the claims, unless the claims explicitly recite the feature. Also, the features, components, steps, concepts, etc. described in the examples in this summary and elsewhere in this disclosure can be combined in a variety of ways. Various features and steps as described elsewhere in this disclosure may be included in the examples summarized here.

In aspects of the present application, a water purifier comprises a water tank and a cover assembly. The water tank comprises a water chamber for storing raw water. The cover assembly comprises a cover assembly shell forming a receiving chamber, a water suction and filtration module configured to filter the raw water to produce purified water; and a water outlet for discharging purified water. The water suction and filtration module comprises a water pump, a filtration unit, and a connecting unit fluidly connecting the water pump and the filtration unit. The receiving chamber is isolated from the water chamber. The water pump and the connecting unit are disposed in the receiving chamber in a substantially horizontal arrangement. The water outlet protrudes from the water tank and the purified water flows downward from the water outlet.

In aspects of the disclosure, the cover assembly comprises a main portion and a protruding portion. The main portion has a flat structure configured to cover an opening of the water tank. The main portion of the cover assembly may have a same or similar horizontal cross-section as the opening of the water tank, so that the main portion of the cover assembly can cover the opening of the water tank. The horizontal cross-section of the main portion may have an outer contour shape selected from the group consisting of square, rectangle, circle, quasi-circle, ellipse, and quasi-ellipse. The protruding portion extends from the water tank horizontally. The water outlet is disposed on the protruding portion, so that the purified water flows downward from the water outlet.

In aspects of the disclosure, the cover assembly shell comprises a top plate, a bottom plate, an inner wall, and an outer wall. The top plate has a first opening, the bottom plate has a second opening, and the inner wall connects edges of the first opening and the second opening to define a water inlet. The water inlet is fluidly communicating with the water chamber. The cover assembly may further comprise a cover plate configured to cover the first opening or the water inlet, to avoid pollutants dropping into the water chamber. In the receiving chamber, the connecting unit may be disposed on the bottom plate.

The receiving chamber may be sealed, so water will not enter the receiving chamber.

In aspects of the disclosure, at least a part of the filtration unit extends beyond the receiving chamber. In other aspects, at least a part of the filtration unit is located in the water chamber. The filtration unit may be oriented vertically. The filtration unit may be detachably in fluid communication with the connecting unit, so that users can replace the filtration unit conveniently.

In aspects, the water suction and filtration module further comprises a water suction pipe. The water suction pipe comprises a first end positioned in the water chamber and a second end in fluid communication with an inlet of the water pump. An outlet of the water pump is in fluid communication with an inlet of the filtration unit; and an outlet of the filtration unit is in fluid communication with the water outlet. The filtration unit may comprise a first receiving shell and a carbon rod disposed inside the first receiving shell, and wherein the carbon rod has an axial through hole, defining a water outlet channel in fluid communication with the outlet of the filtration unit. The inlet and the outlet of the filtration unit are both located at an upper portion of the filtration unit.

In aspects, the filtration unit has an inlet configured to intake raw water, an outlet of the filtration unit is in fluid communication with an inlet of the water pump, and an outlet of the water pump is in fluid communication with the water outlet. The filtration unit may comprise a second receiving shell and resin particles disposed inside the second receiving shell. The inlet and the outlet of the filtration unit are located at a lower portion and an upper portion of the filtration unit, respectively.

In aspects, the cover assembly further comprises a valve unit disposed in the receiving chamber. The valve unit is configured to connect the water suction and filtration module and the water outlet when the water pump is operating, and disconnect the water suction and filtration module and the water outlet when the water pump is not operating.

In aspects, the cover assembly further comprises a TDS detector disposed between the water suction and filtration module and the water outlet in the receiving chamber.

In aspects, the cover assembly further comprises a battery unit. The water pump, the connecting unit and the battery unit are disposed in the receiving chamber in a substantially horizontal arrangement.

In aspects, the cover assembly further comprises a control panel. The control panel is disposed in the receiving chamber and adjacent to the water outlet.

In aspects, the cover assembly is detachably connected to the water tank.

In aspects, the water purifier further comprises a handle pivotally in fluid communication with the water tank.

The water purifier of the present application includes advanced features compared to traditional desktop water purifiers. Firstly, the water outlet protrudes from the water tank and the purified water flows downward from the water outlet. This design makes it easy for users to get purified water. For example, users can place a cup under the water outlet, without having to lift the water tank to pour water. Secondly, the cover assembly comprises a receiving chamber formed by the cover assembly shell. The receiving chamber is isolated from the water chamber. Accordingly, the receiving chamber provides a space for installation of or placing the water pump, the connecting unit, and other units. The cover assembly shell can prevent water from entering the receiving chamber, to ensure normal operation of the water suction and filtration module. More importantly, the water pump and the connecting unit are disposed in the receiving chamber in a substantially horizontal arrangement, i.e., the water pump and the connecting unit are disposed at approximately the same height in the receiving chamber, so the thickness or height of the receiving chamber is small, and the size of the receiving chamber is reduced. The cover assembly shell has a flat and compact structure. Since the cover assembly is compact and the present water purifier does not have a chamber to store purifier water, the water chamber has a relatively large volume for storage raw water. Accordingly, the frequency of refilling water is greatly reduced. Thirdly, t he filtration unit is removably or detachably coupled to the connecting unit, so users can replace the filtration unit easily. Therefore, the present invention provides an improved desktop water purifier which is convenient to use.

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

To further clarify various aspects of the present disclosure, a more particular description of certain examples and implementations will be made by reference to various aspects of the appended drawings. These drawings depict only example implementations of the present disclosure and are not to be considered as limiting the scope of the disclosure. Moreover, while the FIGS. may be drawn to scale for some aspects of the present disclosure, the FIGS. are not necessarily drawn to scale for all aspects described herein. Examples and other features and advantages of the present disclosure will be described and explained with additional specificity and detail through the use of the accompanying drawings, in which:

FIG. 1 is a schematic diagram showing a three-dimensional structure of a water purifier according to one embodiment of the present application.

FIG. 2 is a schematic cross-sectional view of the water purifier of FIG. 1.

FIG. 3 is an enlarged view of part A in FIG. 2.

FIG. 4 is a schematic diagram showing a partial three-dimensional structure of cover assembly 120 (top plate is not shown).

FIG. 5 is a schematic top view showing a partial structure of cover assembly 120 (top plate is not shown).

FIG. 6 is a schematic diagram showing a three-dimensional structure of water suction and filtration module 20.

FIG. 7 is a schematic diagram showing a three-dimensional structure of water suction and filtration module 20′.

The above drawings include the following reference numerals: 11: receiving chamber; 12: water inlet; 13: top plate; 131: connecting through hole; 14: bottom plate; 15: inner wall; 16: outer wall; 20 and 20': water suction and filtration module; 21: water pump; 22 and 22': filtration unit; 23: connecting unit; 231: connector; 24: water suction pipe; 30: water outlet; 40: valve unit; 50: TDS detector; 60: cover plate; 71: the first sealing member; 72: the second sealing member; 73: sealing plug; 74: the third sealing member; 75, the fourth sealing member; 80: UV lamp; 90: control panel; 100: water tank; 101: water chamber; 110: handle; 120: cover assembly.

### DETAILED DESCRIPTION

The following description refers to the accompanying drawings, which illustrate example implementations and various aspects of the present disclosure. Other implementations having different structures and operations do not depart from the scope of the present disclosure.

Disclosed herein are water purifiers. In various aspects, the water purifier comprises a water tank and a cover assembly. The water tank has an opening and a water chamber for storing raw water. The cover assembly is configured to cover the opening of the water tank. In the present application, the cover assembly has a compact structure. Accordingly, the volume of the water chamber is relatively large to store more raw water. The water purifier of the present application effectively solves the problem associated with water purifiers with a small water chamber, i.e., the users need to introduce raw water to the water tank frequently.

Specifically, the cover assembly comprises: a cover assembly shell forming a receiving chamber; a water inlet fluidly communicating with the water chamber; a water suction and filtration module configured to filter the raw water to produce purified water; and a water outlet for discharging purified water. The water suction and filtration module comprises a water pump, a filtration unit, and a connecting unit fluidly connecting the water pump and the filtration unit.

The receiving chamber of the cover assembly is isolated from the water chamber, so some units or components of the water purifier can be placed or installed in the receiving chamber to avoid getting wet, such as the water pump, the connecting unit, control panel, battery unit, etc.

The water pump and the connecting unit are disposed in a substantially horizontal arrangement in the receiving chamber. As used in the present application, the “substantially horizontal arrangement” means that two or more elements or components are disposed approximately at a same height. They can overlap to some extent from a top view, but they are not oriented vertically. In the present application, because the water pump, the connecting unit, and, optionally, other units in the receiving chamber are disposed in the substantially horizontal arrangement, the thickness or the height of the receiving chamber can be reduced to define a compact structure. As such, the cover assembly shell or receiving chamber has a flat structure.

The water outlet protrudes from the water tank and the purified water flows downward from the water outlet. With such design, the user can get water easily without lifting the water tank to pour out purified water.

The filtration unit may be detachably in fluid communication with the connecting unit, so the filtration unit can be easily replaced by users of the water purifier. As used in the present application, “coupled to” means in fluid communication with, which can be a fixed connection using fasteners, or an unfixed connection without any fasteners.

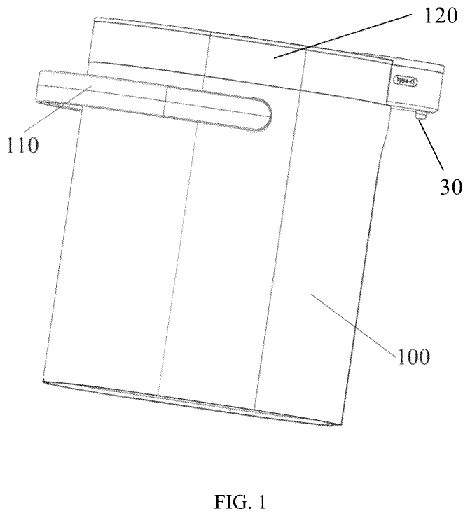

FIG. 1 shows a water purifier according to one embodiment of the present application. The water purifier comprises a water tank 100, a cover assembly 120 covered on the water tank 100, and a handle 110. The cover assembly 120 has a water outlet 30 for discharging purified water. The handle 110 is pivotally in fluid communication with the water tank 100. The handle 110 is configured to be used by the user to move or carry the water purifier easily. The cover assembly 120 is detachably in fluid communication with the upper portion of the water tank 100 to cover the opening of the water tank 100.

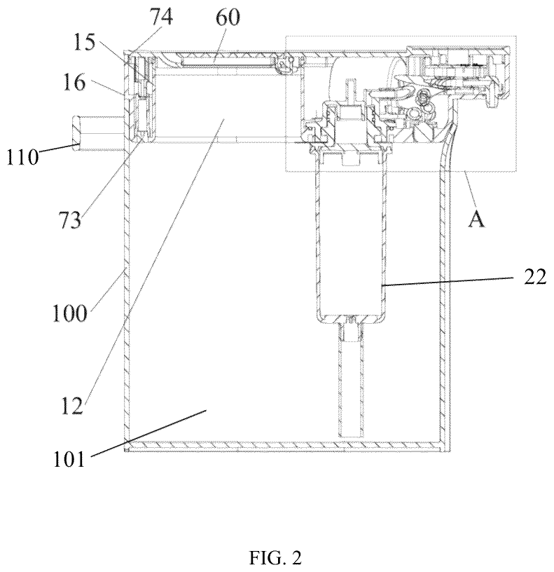

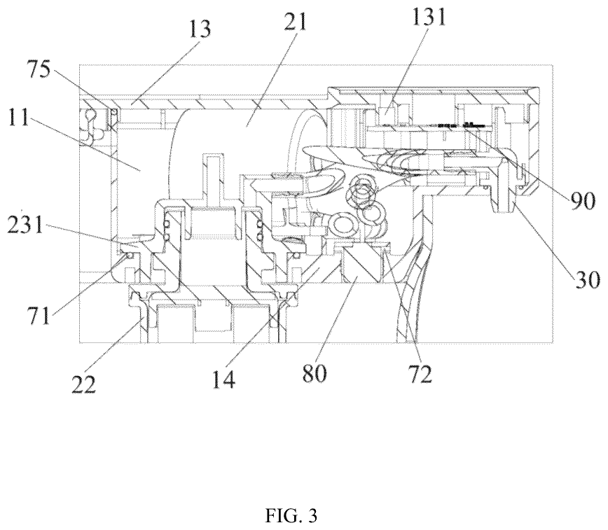

FIG. 2 shows a cross-sectional view of the water purifier shown in FIG. 1, illustrating partial structures of the water tank and the cover assembly. FIG. 3 is an enlarged view of part A in FIG. 2. As shown in FIG. 2, the water tank 100 has a water chamber 101 for storing raw water. The cover assembly has a receiving chamber 11 (shown in FIG. 3). The height of receiving chamber 11 is about ⅕ to ¼ of the height of the water purifier.

As shown in FIGS. 1-2, the water tank 100 has a recessed part under the water outlet 30, so that part of the outer contour of the water tank 100 can be adapted to the outer contour of a cup, which is convenient for the user to use. In addition, a fool-proof indication corresponding to the recessed portion is provided on the cover assembly shell to facilitate the user to assemble the water tank 100 and the cover assembly 120.

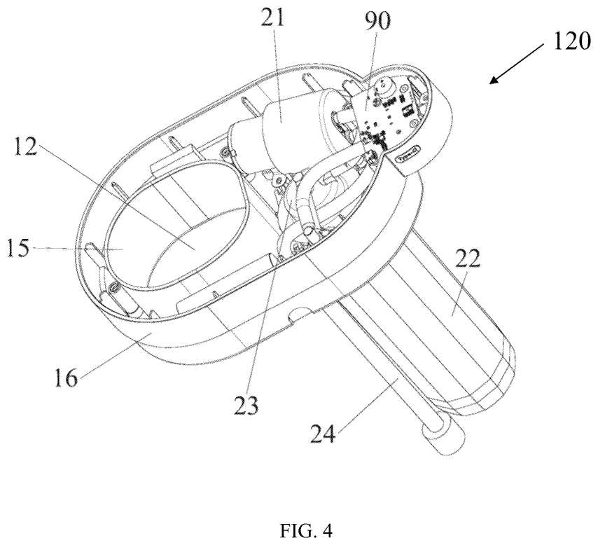

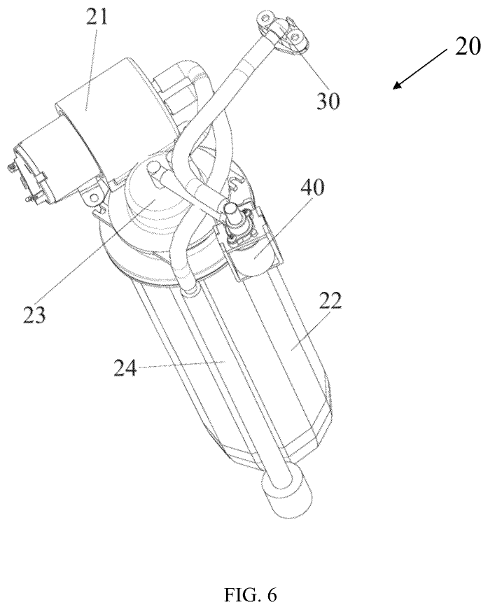

FIGS. 4-6 show detailed structures of the cover assembly 120. The cover assembly 120 comprises a cover assembly shell forming a receiving chamber 11; a water inlet 12; a water suction and filtration module 20; and a water outlet 30. As shown in FIG. 6, the water suction and filtration module 20 comprises a water pump 21, a filtration unit 22, and a connecting unit 23 fluidly connecting the water pump 21 and the filtration unit 22.

As shown in FIGS. 2-5, the cover assembly 120 comprises a main portion and a protruding portion. The main portion has a flat structure covering an opening of the water tank 100, while the protruding portion extends from the water tank 100 horizontally. The opening of the water tank 100 has a quasi-elliptical shape. The main portion has a horizontal cross-section with a quasi-elliptical outer contour. In this embodiment, the main portion of the cover assembly 120 covers the opening of the water tank 100 perfectly and forms a water purifier having a smooth appearance, as shown in FIG. 1. Alternatively, the opening of the water tank and the main portion of the cover assembly may have other shapes, such as square, rectangular, circular, quasi-circular, or elliptical shape. The water outlet 30 is disposed on the protruding portion of the cover assembly 120. In this embodiment, the protruding portion has a semicircular horizontal cross-section. Alternatively, the protruding portion may have a horizontal cross-section of any other shapes.

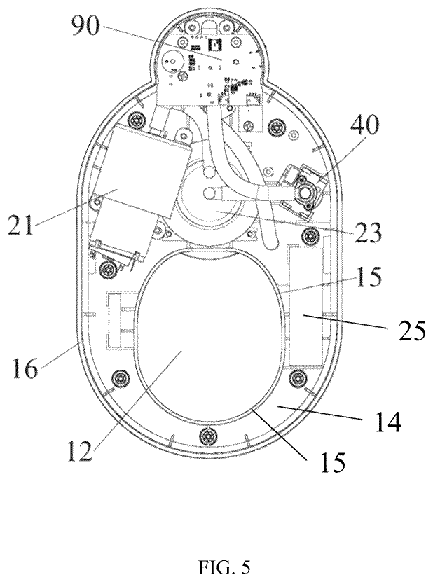

The cover assembly shell includes a top plate 13 (shown in FIG. 5), a bottom plate 14 (shown in FIG. 5), an inner wall 15 and an outer wall 16 (shown in FIG. 4). The receiving chamber 11 is formed between the top plate 13, the bottom plate 14, the inner wall 15 and the outer wall 16.

The water inlet 12 is formed by the inner wall 15. Specifically, the top plate 13 has a first opening, the bottom plate 14 has a second opening corresponding to the first opening, and the inner wall 15 connects the first opening and the second opening to define the water inlet 12. The receiving chamber 11 is around the water inlet 12. Water inlet 12 is to be used by users to introduce raw water into to the water chamber 101. The water inlet 12 is separated from the receiving chamber 11, so the units or components inside the receiving chamber 11 will not get wet or get affected when raw water is introduced into the water chamber through the water inlet 12.

As shown in FIG. 2, the cover assembly further includes a cover plate 60 that can cover the first opening. Specifically, the cover plate 60 is pivotally in fluid communication with the top plate 13 through a rotating shaft, so that the user can open the water inlet 12 when injecting water and cover the first opening when injecting water is not required to prevent the water in the water tank from being polluted. In addition, a buckle portion may be provided on the cover plate 60 to facilitate the user opening or closing the cover plate 60.

As shown in FIGS. 4-5, the cover assembly shell has a horizontal cross section with a quasi-elliptical outer contour, i.e., an elliptical shape plus a small semi-circular shape. The water inlet 12 is located close to a first end of the long axis of the elliptical shape (i.e., lower portion in FIG. 5), while the water outlet 30 is located close to a second end of the long axis of the elliptical shape (i.e., upper portion in FIG. 5). Specifically, the water outlet 30 is located at the small semi-circular shape. As the receiving chamber 11 has a quasi-elliptical horizontal cross section and the water inlet 12 is located close to the first end of the long axis of the quasi-elliptical horizontal cross section, the receiving chamber 11 is generally separated three spaces: a first space close to the second end of the elliptical shape, a second and a third space at two opposing sides of the water inlet 12 along the short axis of the elliptical shape. The first space is large and houses water pump 21 and connecting unit 23, the valve unit 40 (described below). Both the second and the third space are small and narrow.

In the embodiment shown in FIG. 5, water inlet 12 is located close to the first end of the long axis of the elliptical shape (i.e., lower portion in FIG. 5). In other embodiments, the water inlet may be formed in any other position of the cover assembly. For example, the water inlet may be very close to the outer wall 16, so that the inner wall 15 the outer wall 16 share at least a part. In another example, the water inlet may be placed in the middle of the cover assembly (from a top view), but this is not preferred because it will lead to an uncompact structure of the cover assembly.

The cover assembly shell forms a receiving chamber 11, which provides space for the water pump 21, the connecting unit 23 and some other units of the water purifier. The cover assembly shell can prevent water from entering the receiving chamber 11, so the water suction and filtration module 20 can function properly.

As shown in FIGS. 4-5, the pump 21 and the connecting unit 23 are disposed in the receiving chamber 11 in a substantially horizontal arrangement. In other words, the pump 21 and the connecting unit 23 are located at approximately the same height. Because of such arrangement, the thickness or the height of the receiving chamber 11 is reduced. The cover assembly shell or the receiving chamber has a flat structure. As used herein, the “flat structure” means a structure having a larger horizontal size than its vertical size (i.e., height).

The water suction and filtration module 20 can intake raw water, process the raw water into purified water, and then discharge the purified water. During this process, the water pump 21 drives water to flow in the water suction and filtration module 20; the filtration unit 22 processes the raw water into purified water; and the connecting unit 23 connects the water pump 21 and the filtration unit 22.

The connecting unit 23 is configured to connect the water pump 21 and the filtration unit 22. The filtration unit 22 is removably or detachably in fluid communication with the connecting unit 23, so that the user can easily replace the filtration unit 22. As shown in FIG. 3, the connecting unit 23 includes a connector 231 disposed on the bottom plate 14 and extending toward the receiving chamber 11. The filtration unit 22 is detachably coupled to the bottom of the connector 231. A first sealing member 71 is disposed between the connector 231 and the bottom plate 14. Specifically, the bottom plate 14 includes at least one connector mounting hole, and the connector 231 is disposed at the connector mounting hole and is in fluid communication with the bottom plate 14 by bolts. The first sealing member 71 is a sealing ring to prevent water from flowing into the receiving chamber 11 through the gap between the connector 231 and the bottom plate 14, thereby reducing the possibility of water affecting various components in the receiving chamber 11.

At least a part of the filtration unit 22 protrudes or extends out of the cover assembly shell and locates in the water chamber 101. On one hand, when the filtration unit 22 is not completely placed in the receiving chamber 11, the space of the receiving chamber 11 can be saved, thereby reducing the size of the cover assembly and making the overall layout more reasonable. On the other hand, the size of the filtration unit 22 will not be limited by the space of the receiving chamber 11, so a bigger and more powerful filtration unit 22 can be used in the present water purifier. A bigger filtration unit usually means that it contains more filtration media and has a longer service life.

As shown in FIG. 2, the filtration unit 22 extends in a substantially vertical direction. The filtration unit 22 extending in a substantially vertical direction refers to that the filtration unit 22 extending in a vertical direction or in a direction having a certain angle (e.g., less than 15°) relative to the vertical direction. Such arrangement can ensure that the filter medium in the filtration unit 22 is fully in contact with the raw water, so that the filter medium is fully utilized, thereby improving the utilization rate of the filter medium.

As shown in FIGS. 5-6, the water suction and filtration module 20 also includes a valve unit 40 disposed between the filtration unit 22 and the water outlet 30. When the water pump 21 is operating, the valve unit 40 connects the filtration unit 22 and the water outlet 30. When the water pump 21 is shut down, the valve unit 40 disconnects the filtration unit 22 and the water outlet 30. Specifically, the valve unit 40 may be an electromagnetic valve, which is linked with the water pump 21 through the control panel 90 (described below). When the water pump 21 is off, the water pressure in the water channel connected between the filtration unit 22 and the water outlet 30 cannot be released immediately, resulting in water still dripping from the water outlet 30 for a period of time after the water pump 21 is shut down, resulting in a bad user experience. By arranging the valve unit 40 between the filtration unit 22 and the water outlet 30, when the water pump 21 is operating, the valve unit 40 connects the filtration unit 22 and the water outlet 30, so that the purified water can be smoothly discharged from the water outlet 30. When the water pump 21 is shut down, the valve unit 40 disconnects the filtration unit 22 and the water outlet 30, so that after the water pump 21 is shut down, the valve unit 40 can prevent water from continuing to flow to the water outlet 30, thereby avoiding the situation where water continues to drip from the water outlet 30, thereby improving the user experience. As shown in FIG. 5, the valve unit 40 is in the first space as described above. Specifically, the valve unit 40 and the water pump 21 are disposed at the two sides of the connecting unit 23 respectively in the first space. Such an arrangement makes the layout of the structures in the cover assembly shell reasonable and compact.

As shown in FIG. 6, the water suction and filtration module 20 adopts a lift water flow arrangement, which is described as follows. The water suction and filtration module 20 further includes a water suction pipe 24. One end of the water suction pipe 24 extends out of the cover assembly shell and locates in the water chamber 101, and the other end of the water suction pipe 24 is in fluid communication with the inlet of the water pump 21. The outlet of the water pump 21 is in fluid communication with the inlet of the filtration unit 22, and the outlet of the filtration unit 22 is in fluid communication with the water outlet 30. Specifically, based on the operating principle of the water pump, the discharge head of the water pump 21 is generally greater than the suction head, that is, the speed at which water is pumped out by the water pump 21 is greater than the speed at which water is sucked into the water pump 21. According to the above-mentioned lift water flow arrangement, the raw water will first be sucked into the water pump 21 through the suction pipe 24, and then pumped to the filtration unit 22 by the water pump 21. The raw water is then filtered by the filtration unit 22 to define purified water, and the purified water then flows from the filtration unit 22 to the water outlet 30. Since the flow rate of water pumped out by the water pump 21 is relatively high, the filtration efficiency in the water filtration unit 22 is relatively high, and thus the water discharge speed at the water outlet 30 is relatively fast, which can meet the user's needs for quick water purification.

In the present embodiment (i.e., lift water flow arrangement), the filtration unit 22 may include a carbon rod filtration unit, which can remove residual chlorine. The carbon rod filtration unit also has advantages of high filtration accuracy, high structural strength, and good adsorption performance. As an example, the filtration unit 22 may include a first receiving shell and a carbon rod disposed in the first receiving shell. The carbon rod has an axial through hole, defining a water outlet channel and communicates with the outlet of filtration unit 22. The inlet and the outlet of filtration unit 22 may be both located on the upper end of the first receiving shell. Specifically, the outlet of the filtration unit 22 may be at the top end of the filtration unit 22, while the inlet of the filtration unit 22 may be located at a side position at the upper portion of the filtration unit 22 (see FIG. 6). The carbon rod is located in the middle of the first receiving shell. After the raw water enters the first receiving shell from the inlet of the filtration unit 22, it is first located in the cavity between the inner wall of the first receiving shell and the outer wall of the carbon rod. Since a plurality of through holes are provided on the carbon rod, the raw water passes the carbon rod through the plurality of through holes and is purified. Then the purified water enters the axial through hole and is then discharged to the outside of the filtration unit 22 through the outlet of the filtration unit 22.

The cover assembly may further include a battery unit. Preferably, the battery unit, the water pump, the connecting unit and the valve unit are disposed in the receiving chamber in a substantially horizontal arrangement. Usually the battery unit is thin, so it can be disposed in a narrow space of the receiving chamber. As shown in FIG. 5, the battery unit 25 is disposed in the narrow space next to the water inlet 12. This arrangement makes the overall layout inside the cover assembly shell reasonable and ensures a low height of the cover assembly shell.

As shown in FIG. 3, the cover assembly further includes a UV lamp 80 disposed on the bottom plate 14. The UV lamp 80 can sterilize water by irradiation. The lower end of the UV lamp 80 is exposed from the bottom plate 14. A second sealing member 72 is disposed between the UV lamp 80 and the bottom plate 14. Specifically, the bottom plate 14 includes at least one UV lamp mounting hole, and the UV lamp 80 is disposed at the UV lamp mounting hole and disposed on the bottom plate 14 by bolts. The second sealing member 72 is a sealing ring to prevent water from flowing into the receiving chamber 11 from the gap between the UV lamp 80 and the bottom plate 14, thereby reducing the possibility of water affecting various components in the receiving chamber 11. It should be noted that “the lower end of the UV lamp 80 is exposed from the bottom shell 14” means that the light-emitting surface of the UV lamp 80 can be at the same height as the lower surface of the bottom plate 14, or it can be higher or lower than the lower surface of the bottom plate 14.

As shown in FIG. 3, the cover assembly further includes a control panel 90, which is electrically in fluid communication with the water pump 21 to control the water pump 21. A connecting through hole 131 is provided on the top plate 13. The control panel 90 is in the receiving chamber 11 and is in fluid communication with the top plate 13 through a first fastener penetrating the connecting through hole 131. A sealing layer is provided above the connecting through hole 131. Specifically, the control panel 90 is electrically in fluid communication with the water pump 21, the valve unit 40, the TDS detector 50, and the UV lamp 80. A connecting through hole 131 is provided on the top plate 13. The first fastener is a bolt penetrating the connecting through hole 131. The control panel 90 is in fluid communication with the top plate 13 through the first fastener. In order to prevent water from flowing into the receiving chamber 11 from connecting through hole 131, a sealing layer is provided above the connecting through hole 131. A display panel may be provided above the sealing layer, and the display panel is also electrically in fluid communication with the control panel 90.

In some embodiments, the bottom plate 14, the inner wall 15 and the outer wall 16 are formed integrally, i.e., they are formed as one piece. As shown in FIGS. 2-3, t he cover assembly may further include a second fastener penetrating the top plate 13 and the bottom plate 14 and a sealing plug 73 disposed at the lower end of the second fastener. Specifically, the second fastener can be a bolt. The top plate 13 has a first mounting column, and the bottom plate 14 has a second mounting column corresponding to the first mounting column. The second fastener penetrates the first mounting column and the second mounting column. The sealing plug 73 is disposed at the lower end of the second fastener to prevent water from flowing into the receiving chamber 11 from the second mounting column. A third sealing member 74 is disposed between the outer wall 16 and the top plate 13. The third sealing member 74 is an injection molding sealant layer. A fourth sealing member 75 is disposed between the inner wall 15 and the top plate 13, and the fourth sealing member 75 is a sealing ring.

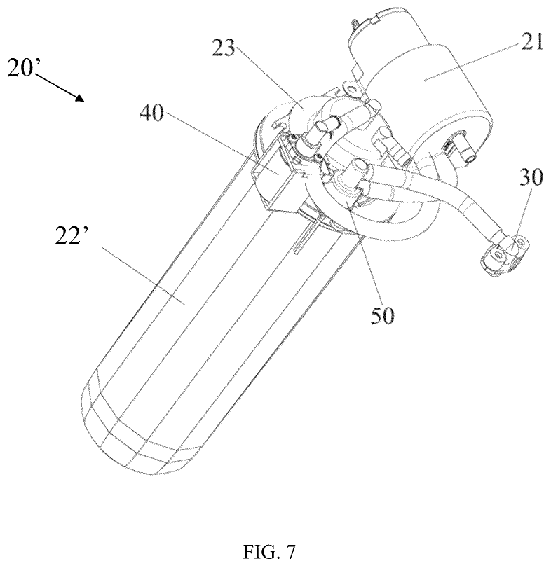

FIG. 7 shows partial structures of a water suction and filtration module 20′ according to another embodiment of the present application. The water suction and filtration module 20′ comprise a water pump 21, a filtration unit 22′, a valve unit 40, and a connecting unit 23. The water suction and filtration module 20′ differs from the water suction and filtration module 20 in the filtration unit and the water flow arrangement. The water suction and filtration module 20′ does not include a water suction pipe. Regarding the water flow arrangement, the water suction and filtration module 20 adopts a lift water flow arrangement, while the water suction and filtration module 20′ adopts a suction water flow arrangement.

In the embodiment shown in FIG. 7, the inlet of the filtration unit 22′ locates at the lower portion of the filtration unit 22′ and forms the water inlet of the water suction filtration module 20′. The outlet of the filtration unit 22 is in fluid communication with the inlet of the water pump 21, and the outlet of the water pump 21 is in fluid communication with the water outlet 30. Specifically, according to the above suction water flow arrangement, the raw water firstly enters the filtration unit 22′ from the inlet of the filtration unit 22 and is filtered to define purified water; the purified water is sucked into the water pump 21, and then pumped out to the water outlet 30 by the water pump 21. Since the flow rate of water sucked by the water pump 21 is relatively low, the raw water can fully contact with filtration medium in the filtration unit 22′, thereby ensuring the filtering effect of the filtration unit 22′ and improving the quality of purified water.

The inlet of the water suction and filtration module 20′ is formed on the filtration unit 22′ and is disposed at the lower portion of the filtration unit 22′. Such an arrangement enables the inlet of the water suction and filtration module 20′ to be fully in contact with the raw water in the water chamber. It should be noted that “the inlet of the water suction and filtration module 20′ is formed on the filtration unit 22′ and is disposed at the lower portion of the filtration unit 22” means that the inlet of the water suction and filtration module 20′ is disposed on the bottom surface of the filtration unit 22′ or at a side position near the bottom end of the filtration unit 22′.

The filtration unit 22′ may include a particle filter. Specifically, the filtration unit 22′ may include a second receiving shell and resin particles disposed in the second receiving shell. The inlet and the outlet of the filtration unit 22′ are respectively located at the two ends of the second receiving shell. Specifically, the inlet of the filtration unit 22′ is located at a lower end of the second receiving shell (i.e., the inlet of the filtration unit 22′ forms the water inlet of the water suction and filtration module 20′ in the present embodiment), and the outlet of the filtration unit 22′ is located at an upper end of the second receiving shell. The type of resin particles can be adjusted to meet the different needs of users. The resin particles can be D113 type resin particles. D113 type resin particles are a type of macroporous weak acid cation exchange resin particles, comprising acrylic acid copolymers which carry a carboxylic acid group. D113 type resin particles have the characteristics of high exchange capacity, small volume change, high strength, good chemical stability, anti-pollution, excellent antioxidant performance, and fast exchange speed. The 13-type resin particles can effectively soften water; the resin particles can also be M20-type resin particles, which are mixed ion exchange resin particles, specifically, mixed bed resin particles after ion balance formed by mixing strong cation exchange resin and strong anion exchange resin. They are fully regenerated and ready-to-use resin particles. M20-type resin particles have advantages of good water quality, long service life, high regeneration efficiency, fast exchange efficiency, good stability, uniform particles, temperature resistance, and high recovery rate. M20-type resin particles can reduce TDS (Total Dissolved Solids, also known as total dissolved solids, is also called total salt content, and its unit is mg/L. TDS indicates how many milligrams of dissolved solids are dissolved in 1 liter of water, that is, the total amount of ions in 1 liter of water, which mainly reflects the concentration of Ca²⁺, Mg²⁺, Na⁺, K⁺, etc. ions in the water); the resin particles in this embodiment can also be composed of a mixture of D113 type resin particles and M20 type resin particles.

The cover assembly of the present application may further comprise a TDS detector. The TDS detector is configured to accurately detect the TDS of purified water. The TDS detector may be disposed in the receiving chamber and between the water suction and filtration module and the water outlet. FIG. 7 shows a TDS detector 50 disposed between the water pump 21 and the water outlet 30.

It should be noted that the terms used herein are only for describing specific embodiments and are not intended to limit the exemplary embodiments according to the present application. As used herein, unless the context clearly indicates otherwise, the singular form is also intended to include the plural form. In addition, it should be understood that when the terms “comprise” and/or “include” are used in this specification, it indicates the presence of features, steps, operations, devices, components and/or combinations thereof. It should be noted that, in the description of the present application, terms such as “up,” “down,” “left,” “right,” “vertical,” “horizontal,” “inside,” and “outside” indicate directions or are terms of positional relationship that are based on the direction or positional relationship shown in the drawings, which are only for the convenience of description, and do not indicate or imply that the device or element must have a specific orientation, be constructed or operated in a specific orientation, and therefore cannot be understood. In addition, the terms “first,” “second,” and the like are used for descriptive purposes only and should not be understood as indicating or implying relative importance. Furthermore, the term “plurality” means two or more, unless otherwise specifically defined. In the present disclosure, unless otherwise specified and so limited, terms such as “installation,” “connection,” and “fixation” should be understood in a broad sense. For example, a connection can be a fixed connection, a detachable connection, an integration, a mechanical connection, an electrical connection, a director connection or indirect connection through an intermediary, or an internal communication of two components or the interaction between two components. Those of ordinary skill in the art can understand the specific meanings of the above terms in the present application according to specific aspects described herein.

Unless otherwise specifically stated, the relative arrangement, numerical expressions and numerical values of the parts and steps set forth in these embodiments do not limit the scope of the utility model. At the same time, it should be understood that, for ease of description, the sizes of the various parts shown in the accompanying drawings are not drawn according to the actual proportional relationship. The technology, method and equipment known to those of ordinary skill in the relevant art may not be discussed in detail, but in appropriate cases, the technology, method and equipment should be considered as a part of the specification. In all examples shown and discussed here, any specific value should be interpreted as being merely exemplary, rather than as a limitation. Therefore, other examples of exemplary embodiments may have different values. It should be noted that similar reference numerals and letters represent similar items in the following drawings, and therefore, once a certain item is defined in an accompanying drawing, it does not need to be further discussed in subsequent drawings.

What is claimed is:

1. A water purifier, comprising a water tank defining a water chamber configured to store raw water; and a cover assembly, the cover assembly comprising:
a cover assembly shell defining a receiving chamber isolated from the water chamber;
a water suction and filtration module comprising a water pump, a filtration unit, and a connecting unit fluidly connecting the water pump and the filtration unit; and
a water outlet configured to discharge purified water;
wherein the water pump and the connecting unit are disposed within the receiving chamber in a substantially horizontal arrangement; and
wherein the water outlet protrudes from the water tank, and the purified water is discharged downward from the water outlet.

2. The water purifier of claim 1, wherein the cover assembly comprises a main portion and a protruding portion; wherein the main portion has a flat structure configured to cover an opening of the water tank; and wherein the protruding portion extends horizontally from the water tank, and the water outlet is disposed on the protruding portion.

3. The water purifier of claim 2, wherein the main portion has a horizontal cross-section with an outer contour shape selected from the group consisting of square, rectangle, circle, quasi-circle, ellipse, and quasi-ellipse.

4. The water purifier of claim 1, wherein the cover assembly shell comprises a top plate, a bottom plate, an inner wall, and an outer wall, wherein the top plate has a first opening, the bottom plate has a second opening, and the inner wall connects edges of the first opening and the second opening to define a water inlet, and wherein the water inlet is in fluid communication with the water chamber.

5. The water purifier of claim 4, wherein the cover assembly further comprises a cover plate configured to cover the first opening.

6. The water purifier of claim 4, wherein the connecting unit is disposed on the bottom plate.

7. The water purifier of claim 1, wherein at least a part of the filtration unit extends beyond the receiving chamber.

8. The water purifier of claim 7, wherein the filtration unit is oriented vertically.

9. The water purifier of claim 1, wherein the filtration unit is detachably in fluid communication with the connecting unit.

10. The water purifier of claim 1, wherein the water suction and filtration module further comprises a water suction pipe, wherein the water suction pipe comprises a first end positioned in the water chamber and a second end in fluid communication with an inlet of the water pump, wherein an outlet of the water pump is in fluid communication with an inlet of the filtration unit; and an outlet of the filtration unit is in fluid communication with the water outlet.

11. The water purifier of claim 10, wherein the filtration unit comprises a first receiving shell and a carbon rod disposed inside the first receiving shell, and wherein the carbon rod has an axial through hole, defining a water outlet channel in fluid communication with the outlet of the filtration unit.

12. The water purifier of claim 10, wherein the inlet and the outlet of the filtration unit are both located at an upper portion of the filtration unit.

13. The water purifier of claim 1, wherein the filtration unit has an inlet configured to intake raw water, wherein an outlet of the filtration unit is in fluid communication with an inlet of the water pump, and an outlet of the water pump is in fluid communication with the water outlet.

14. The water purifier of claim 13, wherein the filtration unit comprises a second receiving shell and resin particles disposed inside the second receiving shell.

15. The water purifier of claim 13, wherein the inlet and the outlet of the filtration unit are located at a lower portion and an upper portion of the filtration unit, respectively.

16. The water purifier of claim 1, wherein the cover assembly further comprises a valve unit disposed in the receiving chamber, wherein the valve unit is configured to fluidly couple the water suction and filtration module to the water outlet when the water pump is operating, and disconnect the water suction and filtration module from the water outlet when the water pump is not operating.

17. The water purifier of claim 1, wherein the cover assembly further comprises a TDS detector disposed between the water suction and filtration module and the water outlet within the receiving chamber.

18. The water purifier of claim 1, wherein the cover assembly further comprises a battery unit, wherein the water pump, the connecting unit and the battery unit are disposed in the receiving chamber in a substantially horizontal arrangement.

19. The water purifier of claim 1, wherein the cover assembly further comprises a control panel, wherein the control panel is disposed in the receiving chamber and adjacent to the water outlet.

20. The water purifier of claim 1, further comprises a handle pivotally connected to the water tank.
